(19) United States
(12) Patent Application Publication
(10) Pub. No.: US 2017/0162015 A1
(43) Pub. Date: Jun. 8, 2017

(54) SECURITY TAG LOCATIONING

(71) Applicant: Checkpoint Systems, Inc., Thorofare, NJ (US)

(72) Inventor: Robert Joseph Langer, Delran, NJ (US)

(21) Appl. No.: 14/957,702

(22) Filed: Dec. 3, 2015

(51) Int. Cl. G08B 13/24

(52) U.S. Cl. CPC G08B 13/2462

(57) ABSTRACT

A mobile tag reader that may be configured to wirelessly communicate with a security tag is provided. The mobile tag reader may include a position estimator, which includes processing circuitry configured to receive information indicative of a position of the mobile tag reader. The processing circuitry may be further configured to receive information indicative of location coordinates of the security tag based on wireless communications between the mobile tag reader and the security tag, The processing circuitry may be further configured to calculate an estimated position of the security tag based on information indicative of the position of the mobile tag reader and the information indicative of the location coordinates of the security tag.

### TECHNICAL FIELD

Various example embodiments relate generally to retail theft deterrent and merchandise protection devices, and more particularly relate to methods and devices for improving location accuracy of security tags employed for such purposes.

### BACKGROUND

Security devices have continued to evolve over time to improve the functional capabilities and reduce the cost of such devices. Some security devices are currently provided to be attached to individual products or objects in order to deter or prevent theft of such products or objects. In some cases, the security devices include tags or other such components that can be detected by gate devices at the exit of a retail establishment and/or tracked while being moved in the retail establishment. These tags may sometimes also be read for inventory management purposes, and may include or otherwise be associated with specific information about the type of product to which they are attached.

In order to improve the ability of retailers to deter theft and/or manage inventory, various improvements may be introduced to attempt to improve location accuracy or to carry out certain specific desired functions related to tracking tags which may also be impacted by location accuracy. Thus, the accuracy of determining the location of the tags may be considered to be an important aspect when determining the appropriate balance of characteristics for a given system.

In some cases, the processing power, memory, or other components that impact the capability of systems or devices to handle computational loads may be somewhat limited. Thus, although fairly complex methods for improving location accuracy have been determined in the past, it is important for some applications to choose a locationing method that provides good performance without providing a heavy computational burden on the systems and devices that are available for use.

### BRIEF SUMMARY OF SOME EXAMPLES

Some example embodiments may provide tag locationing that is not only accurate, but also is not computationally burdensome. Accordingly, tag positioning equipment that can provide for accurate locationing of security tags with a relatively low computational cost can be provided.

In one example embodiment, a mobile tag reader that may be configured to wirelessly communicate with a security tag is provided. The mobile tag reader may include a position estimator, which includes processing circuitry configured to receive information indicative of a position of the mobile tag reader. The processing circuitry may be further configured to receive information indicative of location coordinates of the security tag based on wireless communications between the mobile tag reader and the security tag. The processing circuitry may be further configured to calculate an estimated position of the security tag based on information indicative of the position of the mobile tag reader and the information indicative of the location coordinates of the security tag.

According to another example embodiment, a tag positional estimating system is provided. The security system may include at least one security tag disposed on a product in a monitoring environment; and at least one mobile tag reader configured to wirelessly communicate with a security tag. The mobile tag reader may include a position estimator. The position estimator may include a positioning module; a tag locating module; and processing circuitry. The processing circuitry may be configured to receive information indicative of a position of the mobile tag reader. The processing circuitry may be further configured to receive information indicative of location coordinates of the security tag based on wireless communications between the mobile tag reader and the security tag. The processing circuitry may be even further configured to calculate an estimated position of the security tag based on information indicative of the position of the mobile tag reader and the information indicative of the location coordinates of the security tag.

In another example embodiment, a method of performing tag position estimation for a tag disposed on a product in a monitoring environment is provided. The method may include receiving information indicative of a position of a mobile tag reader. The method may further include receiving information indicative of location coordinates of the security tag based on wireless communications between the mobile tag reader and the security tag. Even further, the method may include calculating an estimated position of the security tag based on information indicative of the position of the mobile tag reader and the information indicative of the location coordinates of the security tag.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a conceptual diagram of a monitoring environment within a retail store in which a mobile tag reader may be employed according to an example embodiment;

FIG. 2 illustrates a further conceptual diagram of a monitoring network within a retail store in which a mobile tag reader may be employed in accordance with an example embodiment;

FIG. 3 illustrates a block diagram of a positional estimator according to an example embodiment;

FIG. 4 illustrates a second order polynomial fit of x and y location coordinates of a security tag estimated at a plurality of positions in a monitoring environment according to an example embodiment;

FIG. 5 illustrates a heat map of x and y location coordinates of a security tag estimated at a plurality of positions in a monitoring environment according to an example embodiment;

FIG. 6 illustrates a block diagram of a system controller according to an example embodiment; and

FIG. 7 illustrates a block diagram showing a control flow representative of an algorithm executable at a position estimator in accordance with an example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability, or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments may enable provision of a system and device capable of monitoring, detecting, and locating security devices (e.g., tags) that are attached to objects such as retail products. In some cases, the tags may be radio frequency identification (RFID) tags. The tags may be read by a mobile tag reader (e.g., a handheld reader, robot, RFID reader, and/or the like) to allow the presence of the tag to be detected and identifying information on the tag to be read. The mobile tag reader may be configured to determine its location and an estimated location of the tags in the monitoring environment. The estimated tag position may be determined for inventory management or theft detection purposes. The process of determining an estimated tag position may be referred to as “locationing” or “tag locationing”.

In this regard, example embodiments may provide for a tag positional estimating system that can simplify the tag position determining processes employed in the system so that accurate positioning may be accomplished with relatively low computational power. In this regard, example embodiments may identify a subset of locating devices that appear to provide the highest quality position determining capability, and then employ a locating calculation or algorithm that greatly simplifies the location determination process, but still provides a relatively accurate locating result. A lighter-weight and potentially cheaper locating system may therefore be employed while still providing relatively accurate tracking and locating capability. The addition of other functionalities that may be desired may therefore be employed with available resources that would otherwise be consumed by costly calculations associated with tag position determination.

An example embodiment will be described herein as it relates to a mobile tag reader that is configured to wirelessly communicate with a tag in order to determine the estimated location of the tag.

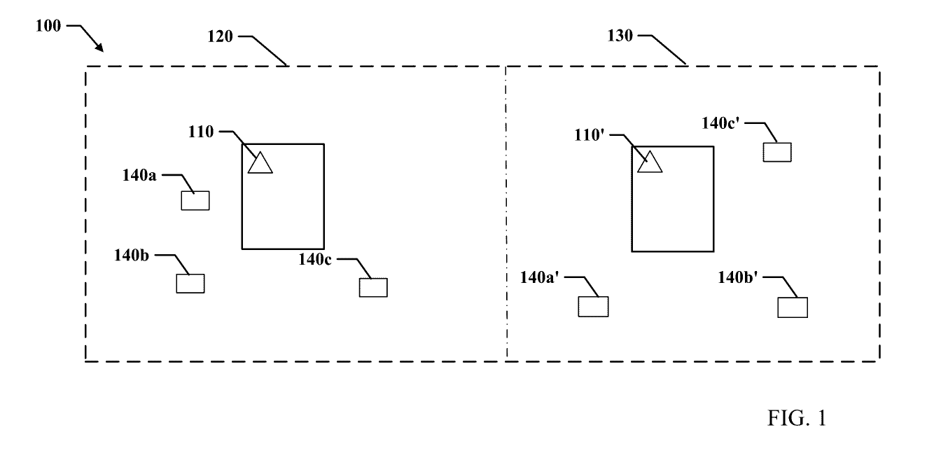

FIG. 1 illustrates a conceptual diagram of a monitoring environment 100 within a retail space in which a mobile tag reader 140 may be employed. As shown in FIG. 1, a mobile tag reader 140 may be used to locate and monitor tags 110 disposed on products in the monitoring environment 100. The mobile tag reader 140 may be controlled, at least in part, via a position estimator 300 located onboard the mobile tag reader 140. The position estimator 300 may include, among other things, processing circuitry, a positioning module, and a tag locating module, which will be described in greater detail below.

As further shown in FIG. 1, the monitoring environment 100 may include a first monitoring zone 120 and a second monitoring zone 130. The first monitoring zone 120 may represent one area of the store (e.g., the sales floor). The second monitoring zone 130 may represent another area of the store (e.g., the warehouse or product storage). The first and second monitoring zones 120 and 130 may be exclusively defined or, in some embodiments, the second monitoring zone 130 may exist within and overlap with the first monitoring zone 120. In some embodiments, the monitoring zones may be further divided into sub-zones. The sub-zones may be correlated with specific departments, locations, or product lines within the store, or alternatively be defined to divide the monitoring environment 100 into conveniently defined regions to facilitate detecting and locating tags 110 within particular regions. Even further, the monitoring environment 100 and respective monitoring zones and subzones may each be converted into a coordinate system such as a Cartesian coordinate system to facilitate the location determination process.

The mobile tag reader 140 may move throughout the first and second monitoring zones 120 and 130 and measure the location of tags 110 located in such zones. The mobile tag reader 140 may read the location of a tag 110 from a plurality of positions in the monitoring zone. For example, the mobile tag reader 140 may read the location of the tag 110 disposed in the first monitoring zone 120 from a plurality of positions that may include a first position 140a, a second position 140b, and a third position 140c. The mobile tag reader 140 may move to the second monitoring zone 130 and measure the location of a second tag 110′ disposed in the second monitoring zone 130 from a plurality of positions that may include a first position 140a′, a second position 140b′, and a third position 140c′.

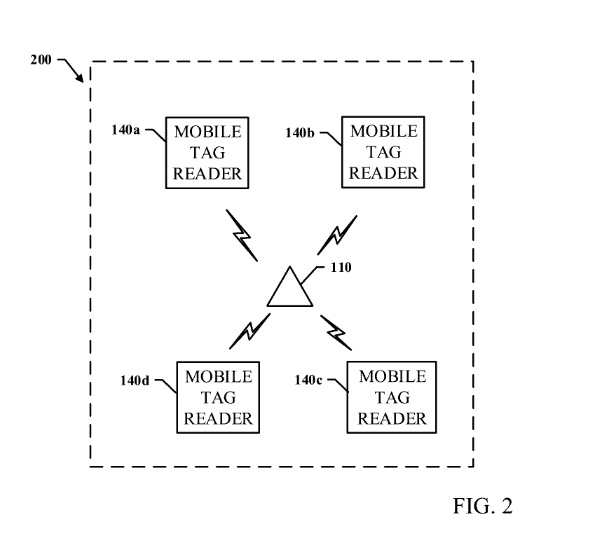

FIG. 2 illustrates a further conceptual diagram of a monitoring environment 200 in which the mobile tag reader 140 may be employed to detect the location of tags within the monitoring environment 100. As shown in FIG. 2, a mobile tag reader 140 may move to a plurality of positions throughout the monitoring environment 200 and estimate the location coordinates of the tag 110 from these positions. The measurements taken by the mobile tag reader 140 may be based on wireless communications between the mobile tag reader 140 and the tag 110. For example, the mobile tag reader 140 may estimate the location coordinates of the tag 110 at the first position 140a, the second position 140b, the third position 140c, and a fourth position 140d. Based on the location coordinates estimated at the plurality of positions, the mobile tag reader 140 may be capable of determining an estimated position of the tag 110 in the monitoring environment 100, as more fully described below. By determining an estimated position of the tag 110 in the monitoring environment 100, the product on which the tag 110 is located may be more efficiently retrieved or located.

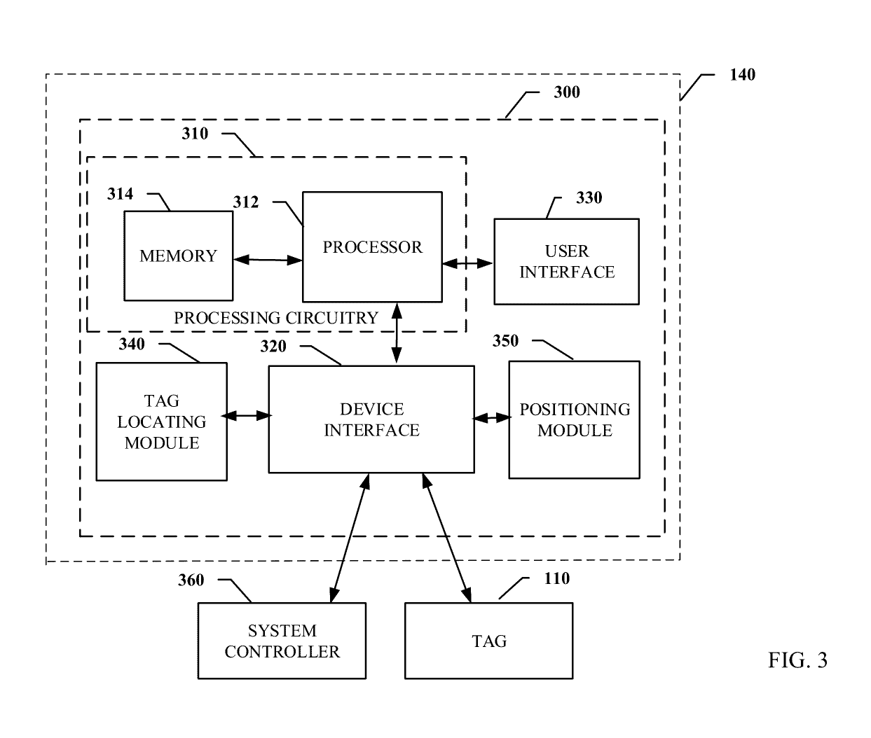

In order to estimate the location coordinates of the tag 110, various forms of technology may be employed by the mobile tag reader 140. For example, angle of arrival (“AOA”) technology may be used. The mobile tag reader 140 may include at least one antenna and may be configured to read signals transmitted by the tag 110. Based on the signals read by the mobile tag reader 140, the mobile tag reader 140 may be configured to estimate an AOA and use the AOA to determine an estimated location of the tag 110. Even further, received signal strength indication (“RSSI”) technology may be used by the mobile tag reader 140. The mobile tag reader 140 may be include at least one antenna and may be configured to determine the power levels of signals transmitted by the tag 110 to use RSSI to determine tag location. Based on the RSSI determined based on signals read by the mobile tag reader 140, the mobile tag reader 140 may be configured to estimate a location of the tag 110. FIG. 3 illustrates a block diagram of a position estimator 300 located onboard the mobile tag reader 140. The position estimator 300 may be configured to determine an estimated position of one or more tags 110 located in a monitoring environment 100 in accordance with an example embodiment. In an example embodiment, the position estimator 300 may be located onboard a handheld version of the mobile tag reader 140. In another example embodiment, the position estimator 300 may be located on a robot that includes or otherwise embodies the mobile tag reader 140, where the robot also includes a mobility assembly that is guided by the position estimator 300.

As shown in FIG. 3, the position estimator 300 may include processing circuitry 310 configured in accordance with an example embodiment as described herein. In this regard, for example, the position estimator 300 may utilize the processing circuitry 310 to provide electronic control inputs to one or more functional units of the position estimator 300 to receive, transmit, and/or process data associated with the one or more functional units and perform communications necessary to enable detecting, monitoring, and locationing of tags, and/or the like as described herein. In some embodiments, the processing circuitry 310 may be embodied as a chip or chip set. In other words, the processing circuitry 310 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320. As such, the processing circuitry 310 may be embodied as a circuit chip (e.g., an integrated circuit chip) configured (e.g., with hardware, software, or a combination of hardware and software) to perform operations described herein.

The device interface 320 may include one or more interface mechanisms for enabling communication with other devices (e.g., tag 110, system controller 360, and/or other devices). In some cases, the device interface 320 may be any means such as a device or circuitry embodied in either hardware, or a combination of hardware and software that is configured to receive and/or transmit data from/to devices or components in communication with the processing circuitry 310 via internal and/or external communication mechanisms. Accordingly, for example, the device interface 320 may further include wireless communication equipment (e.g., one or more antennas) for at least communicating with tags 110 and/or a system controller 360. The device interface 320 may therefore include one or more antenna arrays that may be configured or configurable to receive and/or transmit properly formatted signals associated with the tags 110 and/or the system controller 360. The device interface 320 may further include radio circuitry configured to encode and/or decode, modulate and/or demodulate, or otherwise process wireless signals received by or to be transmitted by the antenna array(s).

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein in reference to execution of an example embodiment.

In some examples, the processor 312 (or the processing circuitry 310) may be embodied as, include or otherwise control the operation of the position estimator 300 based on inputs received by the processing circuitry 310. As such, in some embodiments, the processor 312 (or the processing circuitry 310) may be said to cause each of the operations described in connection with the position estimator 300 in relation to operation of the position estimator 300 relative to undertaking the corresponding functionalities associated therewith responsive to execution of instructions or algorithms configuring the processor 312 (or processing circuitry 310) accordingly. In particular, the processor 312 (or processing circuitry 310) may be configured to enable the position estimator 300 to communicate with the tag 110 to provide information to the system controller 360 that enables the system controller 360 to perform other functions based on the monitoring, detecting, and locationing of the tag 110 or other information received from the position estimator 300 that is determinable from the communications with the position estimator 300.

In an exemplary embodiment, the memory 314 may include one or more non-transitory memory devices such as, for example, volatile and/or non-volatile memory that may be either fixed or removable. The memory 314 may be configured to store information, data, applications, instructions, or the like for enabling the processing circuitry 310 to carry out various functions in accordance with exemplary embodiments of the present invention. For example, the memory 314 may be configured to buffer input data for processing by the processor 312. Additionally or alternatively, the memory 314 may be configured to store instructions for execution by the processor 312. As yet another alternative or additional capability, the memory 314 may include one or more databases that may store a variety of data sets or tables useful for operation of the position estimator 300. Among the contents of the memory 314, applications or instruction sets may be stored for execution by the processor 312 in order to carry out the functionality associated with each respective application or instruction set. In some cases, the applications/instruction sets may include instructions for carrying out some or all of the operations described in reference to the calculations, algorithms, or flow charts described herein. In particular, the memory 314 may store executable instructions that enable the computational power of the processing circuitry 310 to be employed to improve the functioning of the position estimator 300 relative to the functions described herein. As such, the improved operation of the computational components of the position estimator 300 transforms the position estimator 300 into a more capable tracking, notifying, and alarming device relative to the physical objects to which the tag 110 is attached. The processing circuitry 310 may therefore be configured (e.g., by instruction execution) to receive signals from the mobile tag reader 140 and transform attributes of the received signals into data describing the location of the tags 110 for presentation to a user on a terminal or to trigger other functionalities of the mobile tag reader 140.

In an example embodiment, the position estimator 300 may include a positioning module 350. The position estimator 300 may utilize the positioning module 350 to determine the position of the mobile tag reader 140 and define the navigational path of the mobile tag reader 140 as it moves throughout monitoring environment 100. Positional determinations of the mobile tag reader 140 may be made using an accelerometer measuring direction and distance from a known location (e.g., a charging station), GPS, Bluetooth, locating beacons, visual location, LIDAR, and/or other positioning techniques or combinations thereof.

In an example embodiment, the position estimator 300 may also include a tag locater module 340. The position estimator 300 may utilize the tag locater module 340 to receive and determine the location coordinates of the tag 110 based on wireless communications between the mobile tag reader 140 and the tag 110. For example, as described above, the tag locating module 340 may estimate the location coordinates of the tag 110 from a plurality of positions as the mobile tag reader 140 moves throughout the monitoring environment 100. In an example embodiment, the location coordinates may be estimated based on signal strength received from the tags 110. In some cases, the signal strength may be received RSSI technology. In a further example embodiment, the location coordinates may be based on estimating the AOA.

Once the tag locating module 340 estimates the location coordinates of the tag 110 from the plurality of positions in the monitoring environment 100, the position estimator 300 may be configured to estimate the position of the tag 110 by averaging the x coordinates and the y coordinates estimated at the plurality of positions in the monitoring environment 100. The average of all x coordinates may be the estimated x position in the monitoring environment 100. The average of all y coordinates may be the estimated y position in the monitoring environment 100.

Even further, the position estimator 300 may estimate the position of the tag 110 by performing a second order polynomial fit of the x coordinates and the y coordinates estimated at the plurality of positions in the monitoring environment 100. Based on the second order polynomial fit of the x coordinates and the y coordinates, the determined x₁ and y₁ location may be the estimated position of the tag 110 in the monitoring environment 100. If RSSI is used to measure the locations coordinates of the tag 110, the position estimator 300 may be configured to weight RSSI measurements associated with each tag 110 read prior to calculating the estimated position of the tag 100. The weighting may therefore be accomplished based on signal strength. However, in other cases, temporal factors (e.g., most recently received data) or other factors may be used for weighting.

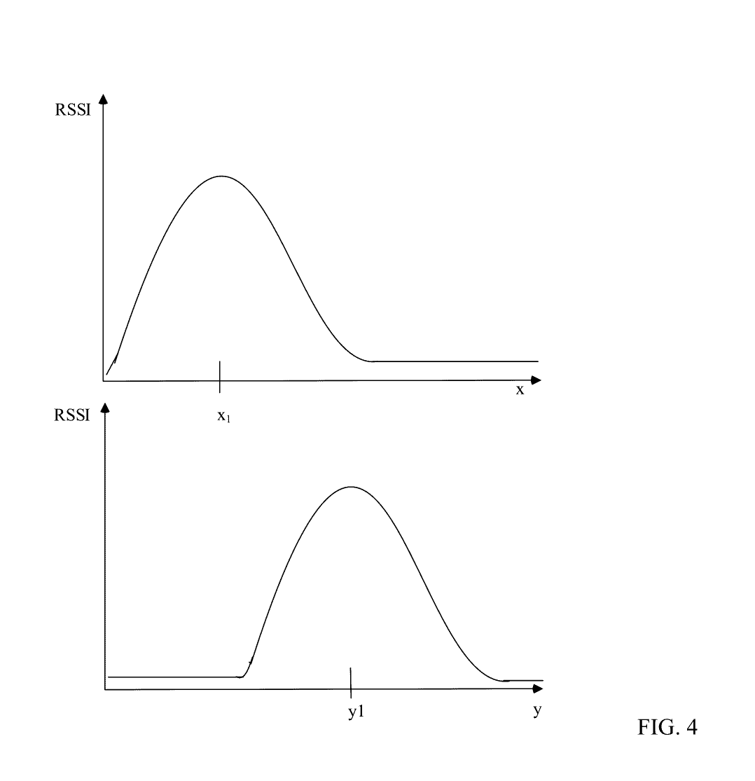

FIG. 4 illustrates a graph of the second order polynomial fit of the x coordinates and the y coordinates estimated at a plurality of positions in the monitoring environment 100. As shown in FIG. 4, the estimated position of the tag 110 may be determined by plotting a second order polynomial fit of each axis in relation to RSSI. The calculated x₁ and y₁ location may represent the estimated position of the tag 110 in the monitoring environment 100.

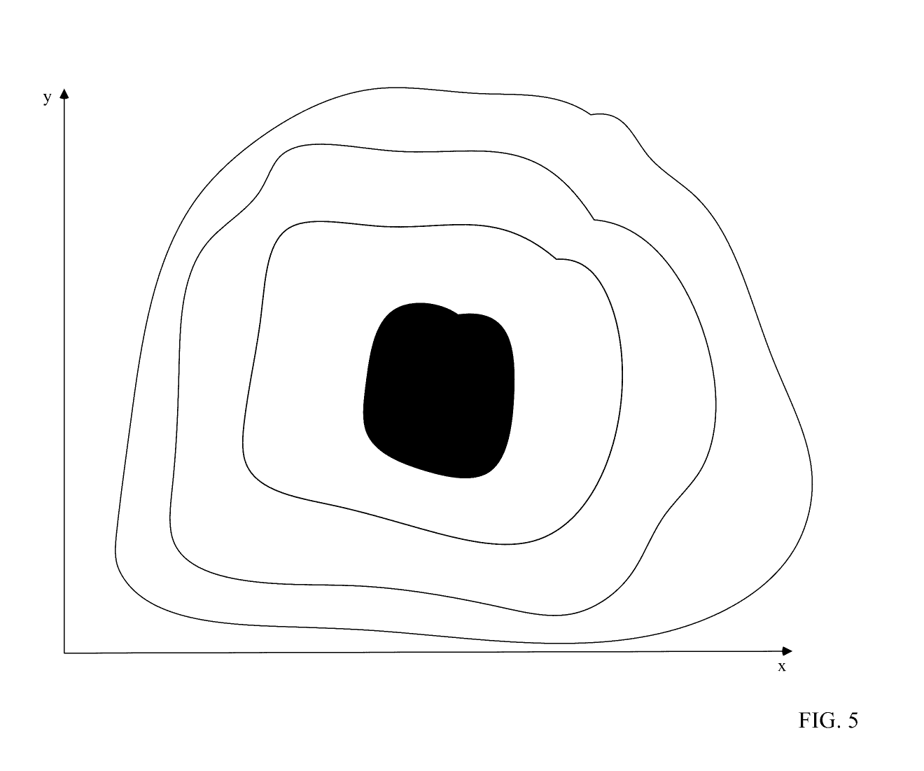

FIG. 5 illustrates a heat map of the x coordinates and the y coordinates of the tag 110, estimated at a plurality of positions in the monitoring environment 100, in relation to RSSI. As shown in FIG. 5, the heat map is a three-dimensional view of the estimated x, y locations in relation to the RSSI, where RSSI is the z-axis. The strongest measured location coordinates indicate those measurements that were taken closest to the tag 110.

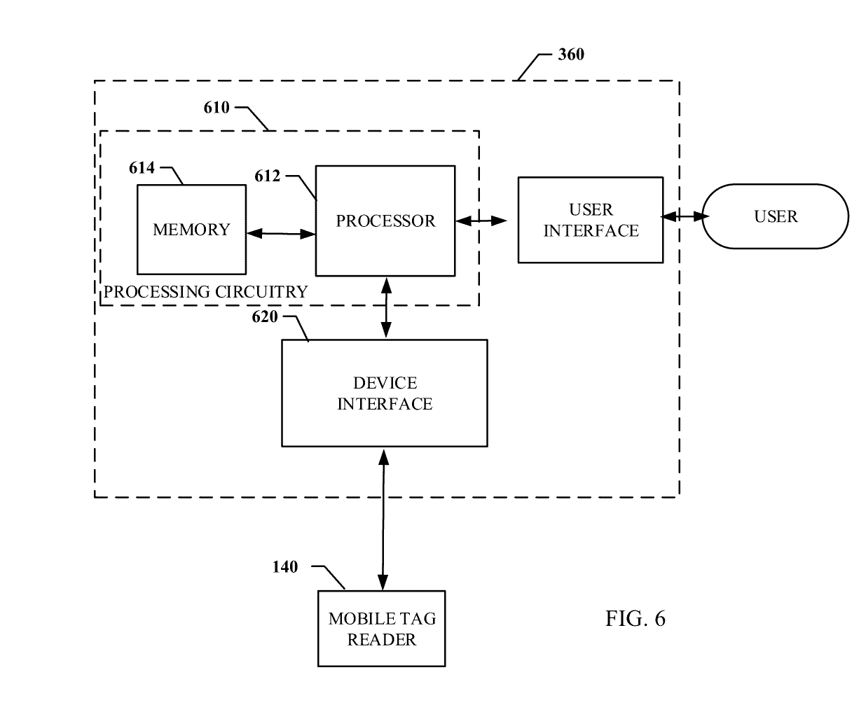

FIG. 6 illustrates a block diagram of the system controller 360 in accordance with an example embodiment. The system controller 360 may be configured to communicate with a plurality of mobile tag readers 140. As shown in FIG. 6, the system controller 360 may include processing circuitry 610 of an example embodiment as described herein. In this regard, for example, the system controller 360 may utilize the processing circuitry 610 to provide electronic control inputs to one or more functional units of the system controller 360 to obtain, transmit, and/or process data associated with the one or more functional units and perform the subsequent locating, detecting, locating, and/or the like described herein. The system controller 360 may also initiate and control the processing of tag 110 location information to perform tag position estimation, as described below.

In some embodiments, the processing circuitry 610 may be embodied in physical and functional form in a similar manner to that which has been described above. However, according to some example embodiments, the processing circuitry 610 may have expanded capabilities with respect to processing speed and communication throughput relative to the processing circuitry 310 utilized by the position estimator 300. For example, the system controller may be configured to receive data from multiple tag readers 140 located within different monitoring zones in a monitoring environment 100. In particular, the system controller 360 may receive data from multiple tag readers 140 and may simultaneously estimate the location of multiple tags 110 located in multiple monitoring zones in a monitoring environment 100 based on the data received from the multiple tag readers 100.

The system controller 360 may be configured to execute the operations described above for the position estimator 300 embodied at the mobile tag reader 140. When the position estimator 300 is not implemented at the system controller 360, the position estimator 300 may process information remotely and act accordingly based on the information. When the position estimator 300 and the system controller 360 split functions, the position estimator 300 and system controller 360 may communicate cooperatively to execute example embodiments. From a technical perspective, processing circuitry embodied at the position estimator 300 or either at the system controller 350 described above may be used to support some or all of the operations described above.

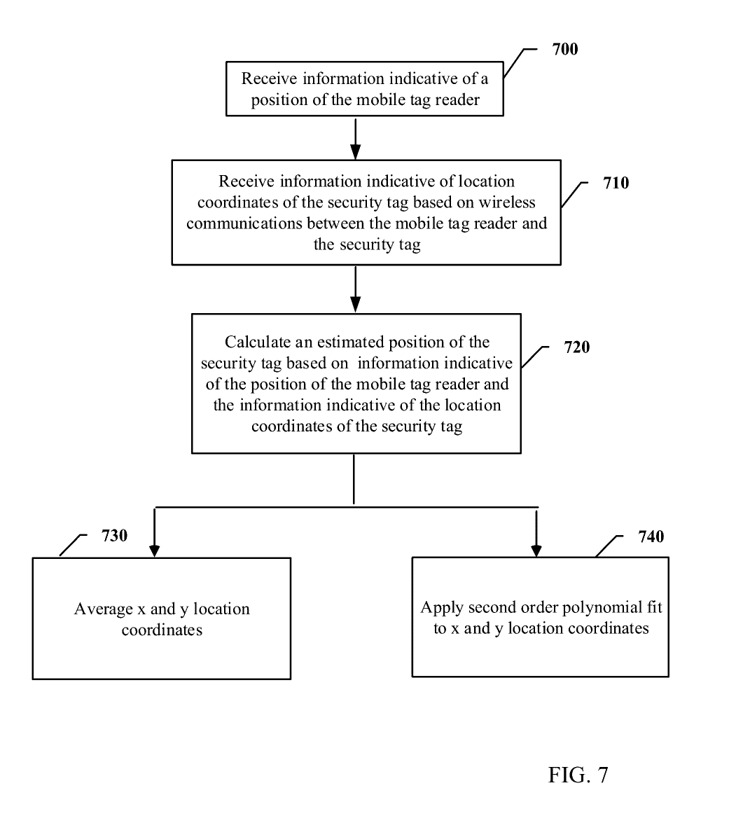

As such, the platforms described in FIGS. 1-6 may be used to facilitate the implementation of several computer program and/or network communication based interactions. As an example, FIGS. 7 and 8 are flowcharts of example methods and program products according to an example embodiment. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a computing device and executed by a processor in the computing device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 7 illustrates a block diagram showing a control flow representative of an algorithm executable at the position estimator 300 (or by processing circuitry 610 at the system controller 360) in accordance with an example embodiment. As shown in FIG. 7, the processing circuitry may initially receive information indicative of a position of the mobile tag reader at operation 700. The process circuitry may then receive information indicative of location coordinates of the security tag based on wireless communications between the mobile tag reader and the security tag at operation 710. Any time/strength weighting of the measurements needed (e.g. if signal strength is used to measure the location coordinates of the tag) may then be applied at operation 710. At operation 720, the estimated position of the security tag is calculated based on information indicative of the position of the mobile tag reader and the information indicative of the location coordinates of the security tag. At operation 730, the estimated position is calculated by taking the average of the x location coordinates and the y location coordinates of a tag estimated at a plurality of positions in the monitoring environment. At operation 740, the estimated position is calculated by applying a second order polynomial fit to the x coordinates and the y coordinates.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A mobile tag reader configured to wirelessly communicate with a security tag, the mobile tag reader comprising a position estimator including processing circuitry configured to:
receive information indicative of a position of the mobile tag reader;
receive information indicative of location coordinates of the security tag based on wireless communications between the mobile tag reader and the security tag; and
calculate an estimated position of the security tag based on information indicative of the position of the mobile tag reader and the information indicative of the location coordinates of the security tag.

2. The mobile tag reader of claim 1, wherein calculating the estimated position of the security tag is based only on information indicative of the position of the mobile tag reader and the information indicative of the location coordinates of the security tag

3. The mobile tag reader of claim 1, wherein the location coordinates of the security tag are based on signal strength.

4. The mobile tag reader of claim 3, wherein the signal strength is received signal strength indication (RSSI), and wherein the processing circuitry is further configured to weight RSSI of the security tag prior to calculating the estimated position of the security tag.

5. The mobile tag reader of claim 1, wherein the estimated position of the security tag is calculated by averaging x and y location coordinates.

6. The mobile tag reader of claim 1, wherein the estimated position of the security tag is calculated by applying a second order polynomial fit to x and y location coordinates.

7. The mobile tag reader of claim 1, wherein the mobile tag reader is handheld.

8. The mobile tag reader of claim 1, wherein the mobile tag reader is a robot.

9. The mobile tag reader of claim 1, mobile tag reader is an RFID tag reader.

10. A tag positional estimating system comprising:
at least one security tag disposed on a product in a monitoring environment; and
at least one mobile tag reader configured to wirelessly communicate with a security tag, the mobile tag reader comprising:
a position estimator comprising:
a positioning module;
a tag locating module; and
processing circuitry configured to:
receive information indicative of a position of the mobile tag reader;
receive information indicative of location coordinates of the security tag based on wireless communications between the mobile tag reader and the security tag; and
calculate an estimated position of the security tag based on information indicative of the position of the mobile tag reader and the information indicative of the location coordinates of the security tag.

11. The positional estimating system of claim 10, wherein calculating the estimated position of the security tag is based only on information indicative of the position of the mobile tag reader and the information indicative of the location coordinates of the security tag.

12. The positional estimating system of claim 10, wherein the location coordinates of the security tag are based on signal strength.

13. The positional estimating system of claim 12, wherein the signal strength is RSSI, and wherein the processing circuitry is further configured to weight RSSI of the security tag prior to calculating the estimated position of the security tag.

14. The positional estimating system of claim 10, wherein the estimated position of the security tag is calculated by averaging x and y location coordinates.

15. The positional estimating system of claim 10, wherein the estimated position of the security tag is calculated by applying a second order polynomial fit to x and y location coordinates.

16. The positional estimating system of claim 10, wherein the mobile tag reader is handheld.

17. The positional estimating system of claim 10, wherein the mobile tag reader is a robot.

18. The positional estimating system of claim 10, wherein the mobile tag reader is an RFID tag reader.

19. A method of performing a tag position estimation for a security tag disposed on a product in a monitoring environment, the method comprising:
receive information indicative of a position of a mobile tag reader;
receive information indicative of location coordinates of the security tag based on wireless communications between the mobile tag reader and the security tag; and
calculate an estimated position of the security tag based on information indicative of the position of the mobile tag reader and the information indicative of the location coordinates of the security tag.

20. The method of claim 19, wherein the location coordinates of the security tag are based on signal strength.
